(19) United States
(12) Patent Application Publication
(10) Pub. No.: US 2021/0129518 A1
(43) Pub. Date: May 6, 2021

(54) Method of Printing

(71) Applicant: Multi Packaging Solutions UK Limited, Nottingham (GB)

(72) Inventors: Barry C. Forbes, Nottingham (GB); Carol Hammond, Nottingham (GB); Tracey Nisbet, Nottingham (GB)

(21) Appl. No.: 17/084,775

(22) Filed: Oct. 30, 2020

(30) Foreign Application Priority Data
Oct. 31, 2019 (GB) 1915856.7

(51) Int. Cl. B41F 5/24; B41M 1/04; B41F 31/26

(52) U.S. Cl. CPC B41F 5/24; B41F 31/26; B41M 1/04

(57) ABSTRACT

The present invention relates to a flexographic printing process comprising: applying an energy-curable primer to at least a portion of a surface of a substrate; curing said energy-curable primer to form a cured primer layer on the substrate; applying a metallic ink to at least a portion of the cured primer layer; and curing or drying the metallic ink; wherein the energy-curable primer is applied using a flexographic printing process; and wherein the metallic ink is applied using a flexographic printing process which uses an anilox roller having a transfer volume of from about 6 cm³/m² to about 30 cm³/m².

### FIELD OF THE INVENTION

The invention relates to a method of printing metallic inks on a substrate using a flexographic printing process. The invention also relates to a device for printing metallic inks on a substrate using a flexographic printing process.

### BACKGROUND OF THE INVENTION

In the printing industry, it is routine to print directly onto a container or packaging that will be used to contain or package a consumer product. In some cases, it is desired for the product container or packaging to have a glossy metallic (i.e. shiny) appearance, in order to help attract the attention of a consumer. For example, product packaging having a glossy metallic appearance is often used for cosmetic or health products, such as toothpaste.

One known method for creating product containers or packaging having a glossy metallic appearance is foil stamping, also known as hot foil stamping. This method of application generally comprises heating a die, applying a metallised polymeric film over the target substrate, and pressing the die onto the substrate through the film. The metal is then transferred off the plastic carrier film and bonded to the substrate. The advantage of this process is that it is a dry process which does not use inks or solvents. However, this process does require the use of a plastic film as a carrier, making it environmentally unfriendly.

An alternative method for creating product containers or packaging having a glossy metallic appearance involves the use of metallised films. Metallised films are polymer films (e.g. polyethylene terephthalate or polypropylene) coated with a thin layer of metal (e.g. aluminium). Once formed, the metallised polymer film can be bonded to a substrate (e.g. paper or card) to provide the substrate with a glossy metallic appearance. For example, a metallised film can be laminated directly onto the board used to form cartons.

One disadvantage of this method is that it requires the use of a plastic film, making it environmentally unfriendly. Furthermore, this plastic film remains on the container or packaging, potentially making the container or packaging difficult to recycle.

Currently, there is a significantly drive in all industries to reduce the use of plastics, and this is also the case in the packaging industry. There is also a drive to ensure that product containers and packaging are as easy to recycle as possible. It would therefore be advantageous to provide an alternative method for producing a substrate having a glossy metallic (i.e. shiny) appearance, wherein the method uses less or no plastic.

A metallic film can also be applied to product containers or packaging by a transfer metallization process. This method involves coating a polymer film (e.g. polyethylene terephthalate or polypropylene) with a release agent, applying a layer of metal (e.g. aluminium) onto the coated polymer film, laminating the film with a substrate, and removing the polymer film. This process therefore provides product containers or packaging having a glossy metallic appearance, but which do not contain a plastic film. This makes the product containers or packaging easier to recycle, although the process does still involve the use of plastics.

A plastic-free method for creating product containers or packaging having a glossy metallic appearance involves printing a metallic ink directly onto a substrate (e.g. paper), optionally after coating the substrate with an energy-curable primer layer. For example, WO 01/07175 discloses a lithographic printing process which comprises providing a substrate with a base of an at least in part UV-cured liquid composition, and applying a liquid composition of metallic character over the base.

Basic lithographic printing involves applying an image to a plate, covering the image area of the plate with ink, and pressing the plate against the substrate to be printed. More commonly, the plate is attached to a cylinder. The process may then comprise applying water to the plate cylinder with dampening rollers to cover the blank portions of the plate. Hydrophobic ink is then applied, which is repelled by the water and adheres to the image area. The plate cylinder is then rolled against a blanket cylinder, which picks up the ink. The ink is then transferred from the blanket cylinder to a substrate.

Lithographic printing is common in the art of printing product containers and packaging, and after the initial set-up the printing can be done very quickly. This makes lithographic printing suitable for producing large quantities of printed substrates. However, the time and cost needed to produce a printing plate make lithographic printing unsuitable for smaller print runs. In addition, the weight and/or thickness of the metallic film that can be applied using this process is very limited.

WO 2007/033031 discloses a printing system for ink-jet printing a metallic effect ink onto a substrate.

Ink-jet printing is a type of printing that recreates a digital image by propelling droplets of ink onto a substrate. An advantage of ink-jet printing is that there are no set-up costs, making it suitable for small print runs or for printing custom products. However, it is not suitable for high volume printing. In addition, metallic effects are extremely difficult to achieve and in some ink-jet processes are not available.

WO 2012/099698 discloses a printing process comprising: applying an energy-curable primer to a first major surface of a paper or paperboard; curing said energy-curable primer to form a cured primer layer; applying a metallic ink to said cured primer layer; and drying said metallic ink. The printing process is preferably a gravure printing process.

WO 2013/134359 discloses a printing process which comprises applying an energy curable ink to a substrate at a first station, curing said energy curably ink at a second station, and applying a metallic ink to said substrate at a third station. The process is preferably a gravure printing process.

Gravure printing typically uses a very dilute ink, with a solids content of less than 10% and a petrochemical based solvent carrier which is driven off in the drying process. This process is therefore legislatively controlled to limit the atmospheric emission of greenhouse gases. Water-based alternatives to the petrochemical solvent-based inks are available, but do not achieve a high lustre metallic effect.

Gravure printing (also called rotogravure printing) involves engraving a gravure cylinder with cells to form the desired image. The cells on the gravure cylinder are then filled with ink and surplus ink is removed from the non-printing surface of the cylinder by a doctor blade. The substrate to be printed is then pressed against the gravure cylinder to transfer ink from the cylinder onto the substrate. Typically one printing unit is used for each colour (e.g. cyan, magenta, yellow, and black).

The advantages of gravure printing include consistent printing quality, durable printing cylinders, and extremely fast printing times. However, the set-up costs can be very high, due to the need to engrave each individual gravure cylinder with a specific design corresponding to the desired image. This means that gravure printing is only suitable for very high volume printing.

Flexographic printing is a form of printing which utilises a flexible relief plate, and can be used to print on almost any type of substrate. A typical flexographic printing process is shown in FIG. 1.

As shown in FIG. 1, a flexographic printing process uses an impression cylinder (3), a plate cylinder (2), and an anilox roller or cylinder (1). The process generally involves the transfer of ink (4) onto the anilox roller (1), after which the ink is transferred from the anilox roller (1) onto the raised portions of the plate cylinder (2). The substrate (5) to be printed is then passed between the plate cylinder (2) and the impression cylinder (3), and the design on the plate is transferred onto the substrate (5).

Flexographic printing is useful for a range of print runs, long and short, as the set up costs have reduced significantly in the last few years. Other advantages of flexographic printing include that a variety of inks can be used, including both water-based and UV curable inks; a wide variety of substrates can be printed on, including both porous and non-porous surfaces; continuous patterns can be easily printed; and fast production speeds can be achieved. In addition, in comparison with lithographic printing, a higher film weight can be applied using flexographic printing. This helps to provide a glossier metallic surface than can be achieved using lithographic printing.

The present invention therefore provides a method for printing metallic inks on a substrate using a flexographic printing process. The process avoids the use of plastics, but still provides substrates having a glossy metallic surface.

### SUMMARY OF THE INVENTION

In one aspect, the invention provides a flexographic printing process comprising:
applying an energy-curable primer to at least a portion of a surface of a substrate;
curing said energy-curable primer to form a cured primer layer on the substrate;
applying a metallic ink to at least a portion of the cured primer layer; and
curing or drying the metallic ink;

wherein the energy-curable primer is applied using a flexographic printing process; and

wherein the metallic ink is applied using a flexographic printing process which uses an anilox roller having a transfer volume of from about 6 cm³/m² to about 30 cm³/m².

In another aspect, the invention is directed to a printing system comprising:
a first station configured to apply an energy-curable primer to at least a portion of a surface of a substrate;
a second station positioned directly downstream of the first station, wherein the second station is configured to cure the energy-curable primer to form a cured primer layer on the substrate;
a third station positioned downstream of the second station, wherein the third station is configured to apply a metallic ink to at least a portion of the cured primer layer;
a fourth station positioned downstream of the third station, which is configured to cure or dry the metallic ink;
wherein the first station comprises a flexographic printer; and
wherein the third station comprises a flexographic printer comprising an anilox roller having a transfer volume of from about 6 cm³/m² to about 30 cm³/m².

### LIST OF FIGURES

FIG. 1 is a schematic illustration of a typical flexographic printing process.

FIG. 2 is a schematic illustration of a cross-section of a flexographic printing plate comprising ink-carrying cells.

FIG. 3 is a schematic illustration of a cross-section of a substrate having a cured primer layer applied thereon.

FIG. 4 is a schematic illustration of a cross-section of a substrate having a cured primer layer and a metallic ink applied thereon.

FIG. 5 shows the steps of an example printing process of the invention.

FIG. 6 shows the steps of an example printing process of the invention.

### DETAILED DESCRIPTION OF THE INVENTION

The present invention provides a method and device for printing metallic inks on a substrate using a flexographic printing process.

Anilox Roller

The anilox roller (1) is an essential part of any flexographic printing process, and the purpose of the anilox roller is to provide a measured and consistent amount of ink to the flexographic printing plate. The anilox roller is a cylinder usually made from steel or aluminium, which has a ceramic or chromed surface coated with or carrying a series of small cells. During printing, the anilox roller is coated with ink, a doctor blade wipes off excess ink, and the ink from the cells is then transferred to the flexographic printing plate. The number, size, and geometry of the anilox cells determines the amount of ink that the anilox roller delivers to the flexographic printing plate.

The transfer volume of an anilox roller is a measure of the volume of ink that will be transferred per unit surface area of the substrate. The is typically quoted in cubic centimetres (of ink) per square meter (of substrate), i.e. cm³/m². Thus, an anilox roller with a transfer volume of 1 cm³/m² will transfer 1 cm³ of ink onto 1 m² of substrate.

The transfer volume may also be quoted as the number of billion cubic microns per square inch, i.e. BCM/in² (sometimes written as BCM).

Generally, in a flexographic printing process, the anilox roller has a transfer volume of around 1 to 4 cm³/m². However, it has surprisingly been found that in a flexographic printing process this is insufficient to provide good quality printing when printing a metallic ink, and instead results in a printed substrate that does not have the desired print quality (e.g. due to poor lustre and/or inconsistent metallic film coverage).

For example, it has been found that when an anilox cylinder having a transfer volume of 5 cm³/m² or less is used in a flexographic printing process for printing a metallic ink, the printed substrate has a low lustre when viewed at an oblique angle. Striations are also visible in the printed image when an anilox roller having a transfer volume of 5 cm³/m² or less is used when printing a metallic ink.

In the process of the present invention, it has therefore been found that the anilox roller used when printing the metallic ink must have a transfer volume of about 6 cm³/m² or more in order for the print quality to be acceptable.

The transfer volume of the anilox roller used when printing the metallic ink must not, however, be too high, as this will also result in a reduction in print quality. Specifically, if too much ink is applied to the substrate the ink will not lie smoothly, and will also dry slowly. A thick layer of ink could therefore suffer from rub and scuff during handling of the substrate.

In the present invention, the anilox roller used when printing the metallic ink has a transfer volume of about 6 cm³/m² or more, preferably about 7 cm³/m² or more, more preferably about 8 cm³/m² or more, and most preferably about 8.5 cm³/m² or more.

The upper limit of the transfer volume of the anilox roller used when printing the metallic ink is about 30 cm³/m², preferably about 25 cm³/m², more preferably about 15 cm³/m², even more preferably about 13 cm³/m², and most preferably about 10 cm³/m².

The anilox rollers used in the present invention when printing the metallic ink therefore have a transfer volume of from about 6 cm³/m² to about 30 cm³/m². It is not necessary for any other anilox roller(s) used in the process of the invention (e.g. the anilox roller used when applying the energy-curable primer) to have this transfer volume.

Preferably, the transfer volume of the anilox roller used when printing the metallic ink is from about 7 cm³/m² to about 25 cm³/m², more preferably from about 8 cm³/m² to about 15 cm³/m², even more preferably from about 8.5 cm³/m² to about 13 cm³/m², and most preferably from about 8.5 cm³/m² to about 10 cm³/m².

Suitable anilox rollers are available commercially, for example from Apex International or Cheshire Anilox Technology Ltd.

Anilox rollers are also characterised by their line count, that is the number of cells per linear inch (LPI) or centimetre (LPCM) at the angle of engraving. In the present invention there is no limitation on the line count of the anilox cylinder used when printing the metallic ink, and the line count chosen may depend on the particles size of the metallic particles in the ink. For example, the line count may range from about 100 LPI to about 1200 LPI. Preferably, the line count ranges from about 100 LPI to about 500 LPI.

Preferably, a doctor blade is used to scrape the anilox roller. This ensures that the ink is only contained within the cells on the anilox roller. Doctor blades are typically made of steel.

Flexographic Printing Plate

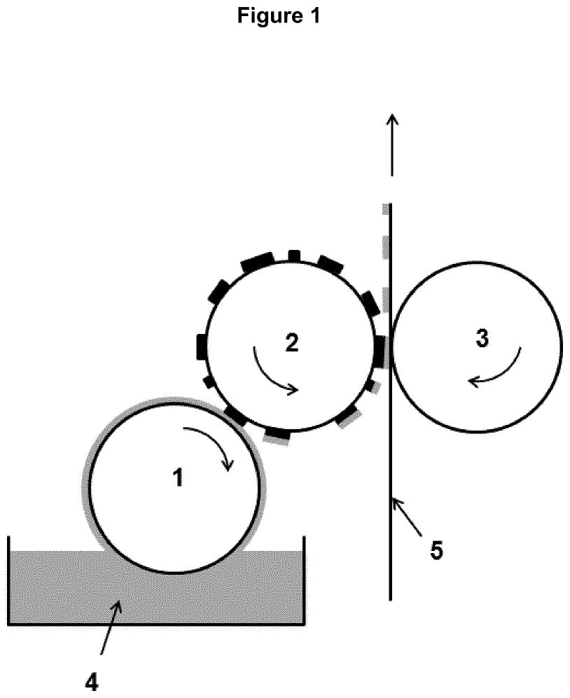

The flexographic printers used in the present invention will also comprise a flexographic printing plate. Flexographic printing plates are flexible photopolymer plates, and are used to transfer ink to a substrate, such as paper. The ink is applied to the flexographic printing plate from the anilox roller, as shown in FIG. 1.

Generally, flexographic printing plates are designed in relief, meaning that the plate comprises (i) a surface to which the ink is applied, and from which the ink is transferred to the substrate, and (ii) one or more etched or relieved portions, which do not come into contact with ink. This type of flexographic plate is shown in FIG. 1 (see the plate cylinder (2)).

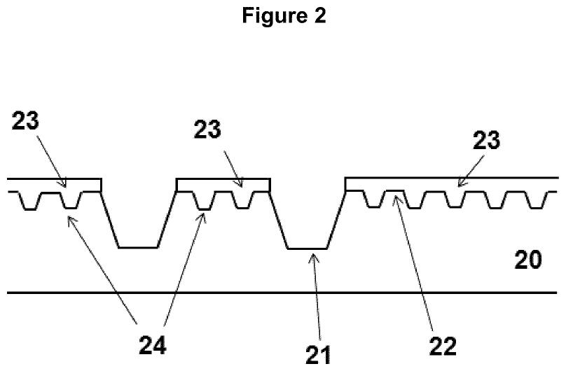

In one embodiment, the flexographic printing plate may comprise ink-carrying cells, as with the anilox roller. These cells are present on the raised (i.e. non-etched) portions of the flexographic printing plate. This embodiment is shown in FIG. 2, which shows a cross-section of a portion of a flexographic printing plate (20). As shown in FIG. 2, the printing plate comprises etched portions (21) which do not come into contact with ink. The plate also comprises raised or non-etched portions (22) to which ink (23) is applied. However, in contrast to a ‘standard’ flexographic printing plate, the raised portions (22) comprise ink-carrying cells (24) which are also capable of carrying the ink once it is applied to the plate.

As can be seen from FIG. 2, the ink-carrying cells (24) on the flexographic plate (20) are shallower in depth than the etched portions (21) of the plate. These ink-carrying cells therefore serve the same purpose as the cells on the anilox roller, that is to help carry the ink.

The number of ink-carrying cells (24) on the flexographic printing plate (20) is not particularly limited, and may be similar to the number of cells on the anilox roller. Thus, the line count of the flexographic printing plate (20) may range from about 100 LPI to about 1200 LPI, preferably from about 100 LPI to about 500 LPI.

During printing using a flexographic printing plate (20) which comprises ink-carrying cells (24), the ink (23) transfers firstly from the cells on the anilox roller to the raised portion (22) and cells (24) on the flexographic printing plate (20), and secondly from the raised portion (22) and cells (24) on the flexographic printing plate (20) to the substrate.

It has surprisingly been discovered that the transfer of ink (23) from the anilox roller is more efficient when using a flexographic printing plate (20) comprising cells (24) which contain the ink (23). This allows for a higher volume of ink transfer. This also ensures that the printing is more even, and is also more cost effective, due to the high cost of the metallic ink. This type of flexographic printing plate is known in the art, for example in US 2001/029859. Suitable flexographic printing plates are available commercially.

The flexographic printing plate (20) described above, which comprises ink-carrying cells (24), may be used in any of the flexographic printing steps or flexographic printers of the present invention. However, the use of a flexographic printing plate comprising ink-carrying cells, as described above, is not necessary.

Primer

Before a metallic ink is applied, the process of the present invention comprises the steps of applying an energy-curable primer to at least a portion of a surface of a substrate; and curing said energy-curable primer to form a cured primer layer.

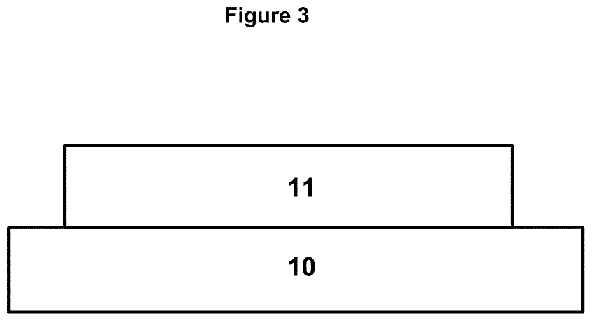

FIG. 3 shows the substrate (10) after application and curing of the primer layer (11) over a portion of the substrate.

The primer layer may be applied over the whole substrate. However, where it is only desired to apply the metallic ink to part of the substrate (e.g. to create a design or pattern), the primer layer need only be applied to the same portion(s) of the substrate that the metallic ink will be applied to.

The terms “energy-curable primer” and “primer” are used interchangeably herein.

The purpose of the primer is to provide an even, smooth surface on the substrate. Where the surface of the substrate is porous, the primer also acts to seal the pores. The metallic ink can then be applied to this smooth/sealed surface. The smooth surface helps to facilitate the orientation of the metallic particles in the metallic ink, such that the particles orientate themselves in a planar fashion on the substrate. This ensures that the reflectance of light of the metallic particles is maximised, ensuring a good reflectivity and lustre of the ink.

In addition, sealing the surface prevents absorption of the metallic ink carrier into the substrate, resulting in a more consistent surface film.

Any suitable energy-curable primer can be used in the present invention, and suitable primers would be known to the person skilled in the art of printing. Suitable energy-curable primers are available commercially, for example from Altana AG, Paragon Products Ltd., Schmid Rhyner AG, and INX International.

The primer may contain a pigment, which can be used to alter the colour or appearance of the final product.

The primer is applied using a flexographic printing process. In the flexographic printing process for applying the primer there is no particular limitation on the nature of the anilox roller, and the skilled person would be able to select a suitable anilox roller for use with the chosen primer. The primer may be applied using an anilox roller having a lower transfer volume than that of the anilox roller which is used when printing the metallic ink. For example, the transfer volume of the anilox roller used in the step of applying the primer may range from about 1 to about 20 cm³/m², preferably from about 3 to about 13 cm³/m², and more preferably from about 5 to about 9 cm³/m². Using higher amounts of primer results in additional unnecessary costs. The line count of the anilox roller may be selected from the ranges disclosed above.

The energy-curable primer may be applied using a flexographic printing plate which comprises ink-carrying cells, as described above.

After the primer is applied to the substrate it is cured or dried. Any suitable curing process may be used, and the skilled person would be well aware of suitable curing processes. For example, the curing process may comprise exposing the substrate to ultraviolet (UV) light. In this case, the primer will be a UV-curable primer.

The carriers of the primer and the metallic ink (or any other ink(s) applied to the primer) should be compatible. For example, when a UV-curable primer is used, the metallic ink is preferably also UV-curable. Any other ink(s) applied to the primer layer are preferably also UV-curable. However, some UV-curable primers/inks are compatible with some water-based primers/inks. It is not therefore necessary for the primer and ink(s) to all be, for example, UV-curable.

Alternatively, the curing process may comprise exposing the substrate to an electron beam (EB). In this case the primer will be an EB-curable primer.

Alternatively, the curing process may comprise exposing the substrate to heat. In this case the primer will be a heat-curable primer.

Preferably, the primer is a UV-curable primer and the curing process comprises exposing the substrate to ultraviolet (UV) light.

The curing step can take place in an inert atmosphere (e.g. under nitrogen), or can take place under atmospheric conditions.

The application of the primer and the subsequent curing step preferably takes place in a single printing unit. However, the primer may be applied by a first printing unit, and the curing may take place in a second printing unit positioned directly downstream from the first printing unit.

As used herein, the term “directly downstream” is intended to mean that the relevant printing unit is positioned downstream of the indicated printing unit, without any additional printing units in between the two printing units. For example, in this case the second printing unit may be positioned downstream of the first printing unit, without any additional printing units in between the first and second printing units.

Metallic Ink

Like the primer, the metallic ink that is used in the present invention is not particularly limited, and may include any metallic ink that is known in the art of metallic ink printing.

Preferably, the metallic ink contains metallic particles that are ‘plate-shaped’ or flat, since these lie flatter on the substrate once printed and as such give better reflectance.

Suitable inks would be known to the skilled person, and are available commercially, e.g. from Sun Chemicals, Schmid Rhyner AG, and INX International.

The metallic ink generally comprises a plurality of metallic particles dispersed in a carrier.

The metallic ink may comprise particles of aluminium, silver, copper, bronze, zinc, or combinations thereof. Preferably, the metallic ink comprises particles of silver, aluminium, or a combination thereof. Most preferably, the metallic ink comprises particles of aluminium.

In the process of the present invention, the metallic ink is applied to at least a portion of the cured primer layer, and is then cured or dried. The metallic ink is applied using a flexographic printing process. Thus, the metallic ink is applied to the substrate from a plate cylinder, via an anilox roller having the transfer volume set out above.

Thus, the transfer volume of the anilox roller used when printing the metallic ink is from about 6 cm³/m² to about 30 cm³/m², preferably from about 7 cm³/m² to about 25 cm³/m², more preferably from about 8 cm³/m² to about 15 cm³/m², even more preferably from about 8.5 cm³/m² to about 13 cm³/m², and most preferably from about 8.5 cm³/m² to about 10 cm³/m².

The metallic ink may be applied using a flexographic printing plate which comprises ink-carrying cells, as described above.

The metallic ink is therefore applied to the substrate in the amount of from about 6 to about 9 g/m². The amount of metallic ink applied to the substrate is generally less than the anilox transfer volume, because not all of the ink is transferred to the substrate via the printing plate.

Preferably, the metallic ink is applied to all of the cured primer layer. In this case, if the primer layer is applied to the whole substrate, the metallic ink will also be applied to the whole substrate.

Alternatively, if the primer layer is only applied to at least a portion of the substrate, the metallic ink may be applied to the same portion(s) of the substrate. At least a portion of the surface of the substrate will therefore remain uncoated by either the primer or the metallic ink. This will allow a design or pattern to be created on the substrate from the metallic ink.

Conversely, the primer layer may be applied to the whole substrate, but the metallic ink may only be applied to at least a portion of the cured primer layer. At least a portion of the surface of the substrate will therefore be coated with a cured primer layer, but will be free of metallic ink. This may also allow a design or pattern to be created on the substrate.

As discussed above, applying the metallic ink to the cured primer layer ensures that the metallic particles in the ink are orientated in a planar fashion, such that there is minimal light scattering off the metallic particles, and more light directed to the human eye or other optical receiver. As such, the metallic ink appears brighter, more brilliant and has a better lustre than when no cured primer layer is present.

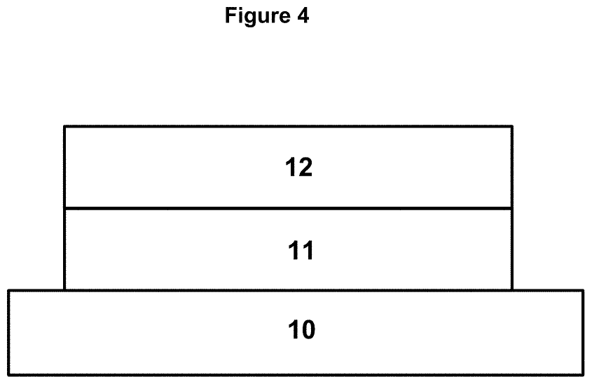

FIG. 4 shows the substrate (10) after application of the metallic ink (12) onto the cured primer layer (11).

Any suitable process for drying or curing the metallic ink may be used, and the skilled person would be well aware of suitable drying or curing processes.

For example, the drying or curing process may comprise exposing the substrate to ultraviolet (UV) light. In this case, the metallic ink will be a UV-curable ink.

Alternatively, the curing or curing process may comprise exposing the substrate to an electron beam (EB). In this case the metallic ink will be an EB-curable ink.

The drying or curing step can take place in an inert atmosphere (e.g. under nitrogen), or can take place under atmospheric conditions.

The application of the metallic ink and the subsequent drying or curing step preferably takes place in a single printing unit. However, the metallic ink may be applied by a printing unit, and the drying or curing may take place in a different printing unit positioned downstream (e.g. directly downstream) from the printing unit where the metallic ink is applied.

As used herein, the terms “cured”, “curing” or “cure” are used interchangeable with “dried”, “drying” or “dry”.

FIG. 4 shows a process of the invention which comprises applying and then curing the primer layer, and then applying and then drying or curing the metallic ink.

Additionally Layers

Although not required, additional layers may be applied to the substrate before or after the primer and/or metallic ink. For example, other metallic or non-metallic inks may be applied to the substrate, for example to portions of the substrate that are not covered by the first metallic ink. In this way the substrate may be printed with different inks to create a desired image, design or pattern. The skilled person would be well aware of how to apply additional inks to create a desired image, design or pattern on the substrate.

The process of the invention may therefore further comprise applying one or more additional inks to at least a portion of the substrate, and curing or drying the one or more additional inks. Each additional ink may be cured or dried before the next ink is applied.

For example, after the primer and/or metallic ink is applied and then dried/cured, the process may further comprise:
applying a second ink to at least a portion of the substrate; and
drying or curing the second ink.

This process may be repeated with further (e.g. third, fourth, fifth, etc.) inks. For example, the process may comprise applying to the substrate and drying, second, third, fourth and fifth inks in turn.

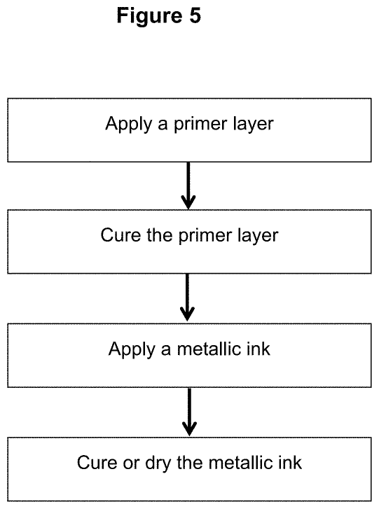

Alternatively, a single drying or curing step can be used to dry or cure the metallic ink and the additional ink(s). An example of such a process is shown in FIG. 5, where one or more additional inks are applied after the metallic ink, and then all of the ink layers are cured or dried together in a single step.

The process of the invention therefore comprises at least two curing or drying steps: one for curing the primer, and one for drying or curing the metallic ink and optionally any other ink layers. However, any number of curing or drying steps may be used. For example, as discussed above, each ink layer may be cured or dried before the addition of the next layer. Alternatively, multiple ink layers can be dried or cured together.

Each additional ink may be applied in any order, and therefore may be applied (i) before the primer layer is applied; (ii) after the primer layer is applied and cured but before the metallic ink is applied; or (iii) after the metallic ink is applied and optionally dried/cured. Of these, options (ii) and (iii) are preferred, with option (iii) being most preferred.

Each of these subsequent inks may be applied directly to the surface of the substrate, to the cured primer layer, to the metallic ink layer, and/or to one of the other ink layers. Thus, the term “applying one or more additional inks to at least a portion of the substrate” does not require that the additional inks are applied directly to the surface of the substrate. Instead, this term encompasses the possibility of applying the additional ink(s) onto the cured primer layer, or onto one of the other ink layer(s).

Each of these subsequent inks may be metallic inks, but preferably these are non-metallic inks. For example, four additional inks may be applied having the colours cyan, magenta, yellow and black.

Each of these subsequent inks may be applied using a lithographic, gravure or flexographic printer. Preferably, the subsequent inks are non-metallic inks and are printed using a lithographic printer.

However, if one or more subsequent metallic ink(s) is applied, the subsequent metallic ink(s) is preferably applied using a flexographic printing process using an anilox roller having the transfer volume set out above (i.e. from about 6 cm³/m² to about 30 cm³/m²).

Alternatively or additionally, one or more coating and/or varnish layers may be applied, preferably after the metallic ink and any other ink layers have been applied to the substrate. Such layers and methods for applying them would be well-known to the skilled person.

For example, the process of the invention may further comprise:
applying a varnish to at least a portion of the substrate; and
drying or curing the varnish.

These steps will preferably take place after the application and drying/curing of any ink layer(s).

The coating and/or varnish layer may be applied using a lithographic or flexographic printer, preferably a flexographic printer. Where a flexographic printer is used to apply the varnish, there is no particular limitation on the line count or transfer volume of the anilox roller. For example, the transfer volume of the anilox roller used when printing the varnish layer may range from about 1 cm³/m² to about 20 cm³/m², preferably from about 3 to about 13 cm³/m², and more preferably from about 5 to about 9 cm³/m². The line count of the anilox roller may be selected from the ranges disclosed above.

The coating and/or varnish layer may be applied using a flexographic printing plate which comprises ink-carrying cells, as described above.

Preferably, the coating and/or varnish layer is applied to the whole substrate.

Substrate

As discussed above, flexographic printing is useful because it can be used to print directly onto a wide range of substrates. Thus, any substrate that can be used in a conventional flexographic printing process can be used in the present invention.

For example, the substrate may be any cellulose-based product in sheet or web form, including, but not limited to, paper, paperboard and cardboard. The substrate may be a single-layered or multi-layered substrate. The substrate may optionally be calendared or embossed.

Printing System

The present invention is also directed to a system for printing metallic inks on a substrate using a flexographic printing process.

The invention is therefore also directed to a printing system comprising:
a first station configured to apply an energy-curable primer to at least a portion of a surface of a substrate;
a second station positioned directly downstream of the first station, wherein the second station is configured to cure the energy-curable primer to form a cured primer layer on the substrate;
a third station positioned downstream of the second station, wherein the third station is configured to apply a metallic ink to at least a portion of the cured primer layer;
a fourth station positioned downstream of the third station, which is configured to cure or dry the metallic ink;
wherein the first station comprises a flexographic printer; and
wherein the third station comprises a flexographic printer comprising an anilox roller having a transfer volume of from about 6 cm³/m² to about 30 cm³/m².

As used herein, the term “directly downstream” means that the relevant station is positioned downstream of the station referred to, without any additional stations in between. Thus, the second station is positioned directly downstream of the first station, such that no other stations are between these two stations. However, additional stations may be present between the second and third stations, or between the third and fourth stations.

Preferably, the flexographic printers used herein comprise:
an impression cylinder (3);
a plate cylinder (2); and
an anilox roller (1).

In the flexographic printers used to apply the metallic ink, the anilox roller (1) has a transfer volume of from about 6 cm³/m² to about 30 cm³/m².

In the flexographic printers used to apply the energy-curable primer, the anilox roller preferably has a transfer volume of from about 1 to about 20 cm³/m², more preferably from about 3 to about 13 cm³/m², and most preferably from about 5 to about 9 cm³/m².

As used herein, the term “station” may comprise a printing unit which is configured to apply a primer or ink (e.g. a metallic ink) to the substrate. The “station” may alternatively comprise a drying unit, which is configured to cure or dry the primer or any inks (e.g. the metallic ink) that are applied at previous stations. A printing unit and the corresponding drying unit may be separate, or may be part of the same larger unit.

The invention therefore encompasses a printing system comprising:
a first printing unit configured to apply an energy-curable primer to at least a portion of a surface of a substrate;
a first drying unit positioned directly downstream of the first printing unit, wherein the first drying unit is configured to cure the energy-curable primer to form a cured primer layer on the substrate;
a second printing unit positioned downstream of the first drying unit, wherein the second printing unit is configured to apply a metallic ink to at least a portion of the cured primer layer;
a second drying unit positioned downstream of the second printing unit, wherein the second drying unit is configured to cure or dry the metallic ink;
wherein the first printing unit comprises a flexographic printer; and
wherein the second printing unit comprises a flexographic printer comprising an anilox roller having a transfer volume of from about 6 cm³/m² to about 30 cm³/m².

The invention also encompasses a printing system comprising:
a first printing unit configured to apply an energy-curable primer to at least a portion of a surface of a substrate and then cure the energy-curable primer to form a cured primer layer on the substrate;
a second printing unit positioned downstream of the first printing unit, wherein the second printing unit is configured to apply a metallic ink to at least a portion of the cured primer layer, and then cure or dry the metallic ink;
wherein the first printing unit comprises a flexographic printer; and
wherein the second printing unit comprises a flexographic printer comprising an anilox roller having a transfer volume of from about 6 cm³/m² to about 30 cm³/m².

The printing system may further comprise any number of further stations (including printing and/or drying units) positioned upstream, further downstream or in between the stations discussed above. The printing system may therefore further comprise one or more additional stations which may each comprise a lithographic printer, gravure printer or a flexographic printer, said one or more stations being configured to apply one or more additional inks and/or varnish layers.

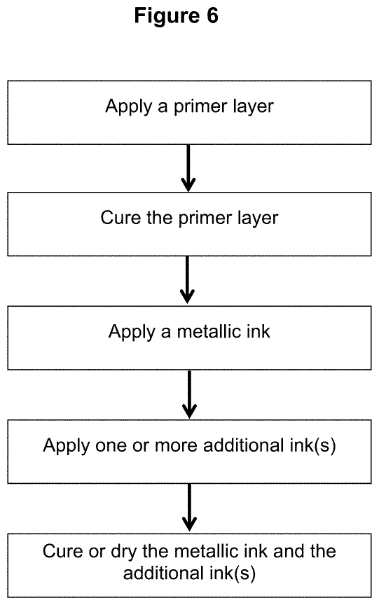

For each additional station which is present and which is configured to apply an additional ink or a varnish layer, there may also be a corresponding station positioned directly downstream which is configured to dry/cure the additional ink/varnish layer. However, in some systems multiple layers can be dried or cured at once. For example, multiple inks may be applied before all the inks are cured/dried at a single curing/drying station (as shown in FIG. 6).

For example, the printing system may further comprise from about 6 to about 18 further stations, which are each configured to apply or cure/dry additional inks and/or varnishes.

The first, third, fifth, etc. additional stations may be configured to each apply an ink or varnish to at least a portion of a substrate, and the second, fourth, sixth, etc. additional stations may be configured to each cure or dry the ink or varnish applied at the previous station.

As discussed above, these additional stations may be present in any order, and may be positioned upstream, downstream or in between the stations configured to apply and cure/dry the primer and metallic ink.

Preferably, any additional stations are positioned downstream of the second station, such that any inks and/or varnishes are applied to the substrate after the primer has been applied and cured. However, the primer and/or the metallic ink may be applied to the substrate after any additional inks are applied and dried/cured.

Additionally, any additional stations configured to apply or cure/dry a varnish are preferably positioned downstream of any stations configured to apply or cure/dry a primer, metallic ink or other ink.

The printing system of the present invention may therefore comprise:
a first station configured to apply an energy-curable primer to at least a portion of a surface of a substrate;
a second station positioned directly downstream of the first station, wherein the second station is configured to cure the energy-curable primer to form a cured primer layer on the substrate;
a third station positioned downstream of the second station, wherein the third station is configured to apply a metallic ink to at least a portion of the cured primer layer;
a fourth station positioned downstream of the third station, herein the fourth station is configured to cure or dry the metallic ink;
wherein the first station comprises a flexographic printer;
wherein the third station comprises a flexographic printer comprising an anilox roller having a transfer volume of from about 6 cm³/m² to about 30 cm³/m²; and
wherein the system further comprises one or more additional stations, each of which is configured to apply an additional ink or varnish to at least a portion of a substrate, and optionally one or more additional stations configured to cure or dry the additional ink(s) or varnish(es).

By “at least a portion of a substrate” it is meant that the additional ink or varnish can be applied directly to the substrate, or to at least a portion of the cured primer layer on the substrate, or to at least a portion of any other layer which has already been applied to the substrate.

As discussed above, the number of additional stations is preferably from 6 to 18, more preferably from 6 to 12.

By the application of multiple layers of additional inks, which may be different colours, a pattern, image or design can be created on the substrate.

In the above system, each of the one or more additional stations is preferably positioned downstream of the second station. For example, each of the one or more additional stations may be independently positioned either (i) downstream of the second station and upstream of the third station, (ii) downstream of the third station, or (iii) downstream of the fourth station. Preferably, each of the one or more additional stations is positioned downstream of the third station, more preferably downstream of the fourth station.

Any additional stations which are configured to apply or cure/dry a varnish are preferably positioned downstream of all the other stations.

Preferably, any additional stations configured to apply a varnish comprise a flexographic printer configured to apply a varnish.

Any additional stations which are configured to apply an ink are preferably configured to apply an ink which is not a metallic ink. In this case, each of these additional stations preferably comprise a lithographic printer configured to apply an ink which is not a metallic ink.

However, if any additional stations are configured to apply another metallic inks, the additional station(s) will preferably comprise a flexographic printing printer comprising an anilox roller having the transfer volume set out above (i.e. from about 6 cm³/m² to about 30 cm³/m²).

### Embodiments

Below is given a list of particular embodiments of the present disclosure. It will be appreciated that the features of any of these embodiments may be used either separately, or in any combination.

Embodiment 1. A flexographic printing process comprising:
applying an energy-curable primer to at least a portion of a surface of a substrate;
curing said energy-curable primer to form a cured primer layer on the substrate;
applying a metallic ink to at least a portion of the cured primer layer; and
curing or drying the metallic ink;

wherein the energy-curable primer is applied using a flexographic printing process; and

wherein the metallic ink is applied using a flexographic printing process which uses an anilox roller having a transfer volume of from about 6 cm³/m² to about 30 cm³/m².

Embodiment 2. The process of embodiment 1, wherein the metallic ink is applied using a flexographic printing process which uses an anilox roller having a transfer volume of from about 7 cm³/m² to about 25 cm³/m², preferably from about 8 cm³/m² to about 15 cm³/m², more preferably from about 8.5 cm³/m² to about 13 cm³/m², and most preferably from about 8.5 cm³/m² to about 10 cm³/m².

Embodiment 3. The process of embodiment 1 or 2, wherein the metallic ink is applied using a flexographic printing process which uses an anilox roller having a line count of from about 100 LPI to about 1200 LPI.

Embodiment 4. The process of any of embodiments 1-3, wherein the primer is a UV-curable primer, and wherein the step of curing the primer layer comprises exposing the substrate to UV light.

Embodiment 5. The process of any of embodiments 1-4, wherein the metallic ink is a UV-curable ink, and wherein the step of curing the metallic ink comprises exposing the substrate to UV light.

Embodiment 6. The process of any of embodiments 1-5, wherein energy-curable primer is applied using a flexographic printing process which uses an anilox roller having a transfer volume of from about 1 cm³/m² to about 20 cm³/m².

Embodiment 7. The process of any of embodiments 1-6, wherein the energy-curable primer is applied using a flexographic printing process which uses an anilox roller having a line count of from about 100 LPI to about 1200 LPI.

Embodiment 8. The process of any of embodiments 1-7, wherein the process further comprises applying one or more additional inks to at least a portion of the substrate, and curing or drying the one or more additional inks.

Embodiment 9. The process of embodiment 8, wherein each of the one or more additional inks are non-metallic inks.

Embodiment 10. The process of embodiment 8, wherein one or more of the additional inks are additional metallic inks, preferably wherein the one or more additional metallic inks are applied using a flexographic printing process which uses an anilox roller having a transfer volume of from about 6 cm³/m² to about 30 cm³/m².

Embodiment 11. The process of embodiment 9, wherein each of the one or more additional inks is applied using a lithographic printing process.

Embodiment 12. The process of any of embodiments 1-11, wherein the process further comprises applying one or more varnish layers to at least a portion of the substrate, and curing or drying the one or more varnish layers.

Embodiment 13. The process of embodiment 12, wherein the one or more varnish layers are applied using a flexographic printing process, preferably wherein the flexographic printing process uses a flexographic printing plate comprising ink-carrying cells.

Embodiment 14. The process of any of embodiments 1-13, wherein the substrate is a cellulose-based product.

Embodiment 15. The process of embodiment 14, wherein the substrate is selected from paper, paperboard and cardboard.

Embodiment 16. The process of any of embodiments 1-15, wherein the energy-curable primer and/or the metallic ink are applied using a flexographic printing process which uses a flexographic printing plate comprising ink-carrying cells.

Embodiment 17. A printing system comprising:
a first station configured to apply an energy-curable primer to at least a portion of a surface of a substrate;
a second station positioned directly downstream of the first station, wherein the second station is configured to cure the energy-curable primer to form a cured primer layer on the substrate;
a third station positioned downstream of the second station, wherein the third station is configured to apply a metallic ink to at least a portion of the cured primer layer;
a fourth station positioned downstream of the third station, wherein the fourth station is configured to cure or dry the metallic ink;
wherein the first station comprises a flexographic printer; and
wherein the third station comprises a flexographic printer comprising an anilox roller having a transfer volume of from about 6 cm³/m² to about 30 cm³/m².

Embodiment 18. The printing system of embodiment 17, wherein the third station comprises a flexographic printer comprising an anilox roller having a transfer volume of from about 7 cm³/m² to about 25 cm³/m², preferably from about 8 cm³/m² to about 15 cm³/m², more preferably from about 8.5 cm³/m² to about 13 cm³/m², and most preferably from about 8.5 cm³/m² to about 10 cm³/m²

Embodiment 19. The printing system of embodiment 17 or 18, wherein the first station comprises a flexographic printer comprising an anilox roller having a transfer volume of from about 1 to about 20 cm³/m².

Embodiment 20. The printing system of any of embodiments 17-19, wherein the system further comprises one or more additional stations, each of which is configured to apply an additional ink or varnish to at least a portion of a substrate.

Embodiment 21. The printing system of embodiment 20, wherein the system further comprises one or more additional stations, each of which is configured to cure or dry one or more of the additional inks or varnishes.

Embodiment 22. The printing system of embodiment 20 or 21, wherein the one or more additional stations is each positioned downstream of the second station, and preferably also downstream of the fourth station.

Embodiment 23. The printing system of any of embodiments 20-22, wherein at least one of the one or more additional stations is configured to apply a non-metallic ink.

Embodiment 24. The printing system of any of embodiments 17-23, wherein each flexographic printer comprises a flexographic printing plate comprising ink-carrying cells.

1. A flexographic printing process comprising:
applying an energy-curable primer to at least a portion of a surface of a substrate;
curing said energy-curable primer to form a cured primer layer on the substrate;
applying a metallic ink to at least a portion of the cured primer layer; and
curing or drying the metallic ink;
wherein the energy-curable primer is applied using a flexographic printing process; and
wherein the metallic ink is applied using a flexographic printing process which uses an anilox roller having a transfer volume of from about 6 cm³/m² to about 30 cm³/m².

2. The process of claim 1, wherein the metallic ink is applied using a flexographic printing process which uses an anilox roller having a transfer volume of from about 7 cm³/m² to about 25 cm³/m².

3. The process of claim 1, wherein the metallic ink is applied using a flexographic printing process which uses an anilox roller having a line count of from about 100 LPI to about 1200 LPI.

4. The process of claim 1, wherein the primer is a UV-curable primer, and wherein the step of curing the primer layer comprises exposing the substrate to UV light.

5. The process of claim 1, wherein the metallic ink is a UV-curable ink, and wherein the step of curing the metallic ink comprises exposing the substrate to UV light.

6. The process of claim 1, wherein energy-curable primer is applied using a flexographic printing process which uses an anilox roller having a transfer volume of from about 1 cm³/m² to about 20 cm³/m².

7. The process of claim 1, wherein the energy-curable primer is applied using a flexographic printing process which uses an anilox roller having a line count of from about 100 LPI to about 1200 LPI.

8. The process of claim 1, wherein the process further comprises applying one or more additional inks to at least a portion of the substrate, and curing or drying the one or more additional inks.

9. The process of claim 1, wherein the process further comprises applying one or more varnish layers to at least a portion of the substrate, and curing or drying the one or more varnish layers.

10. The process of claim 9, wherein the one or more varnish layers are applied using a flexographic printing process.

11. The process of claim 1, wherein the substrate is a cellulose-based product.

12. The process of claim 1, wherein the energy-curable primer and/or the metallic ink are applied using a flexographic printing process which uses a flexographic printing plate comprising ink-carrying cells.

13. A printing system comprising:
a first station configured to apply an energy-curable primer to at least a portion of a surface of a substrate;
a second station positioned directly downstream of the first station, wherein the second station is configured to cure the energy-curable primer to form a cured primer layer on the substrate;
a third station positioned downstream of the second station, wherein the third station is configured to apply a metallic ink to at least a portion of the cured primer layer;
a fourth station positioned downstream of the third station, wherein the fourth station is configured to cure or dry the metallic ink;
wherein the first station comprises a flexographic printer; and
wherein the third station comprises a flexographic printer comprising an anilox roller having a transfer volume of from about 6 cm³/m² to about 30 cm³/m².

14. The printing system of claim 13, wherein the third station comprises a flexographic printer comprising an anilox roller having a transfer volume of from about 7 cm³/m² to about 25 cm³/m².

15. The printing system of claim 13, wherein the first station comprises a flexographic printer comprising an anilox roller having a transfer volume of from about 1 to about 20 cm³/m².

16. The printing system claim 13, wherein the system further comprises one or more additional stations, each of which is configured to apply an additional ink or varnish to at least a portion of a substrate.

17. The printing system of claim 16, wherein the system further comprises one or more additional stations, each of which is configured to cure or dry one or more of the additional inks or varnishes.

18. The printing system of claim 16, wherein the one or more additional stations is each positioned downstream of the second station.

19. The printing system of claim 16, wherein at least one of the one or more additional stations is configured to apply a non-metallic ink.

20. The printing system of claim 13, wherein each flexographic printer comprises a flexographic printing plate comprising ink-carrying cells.
